(19) United States
(12) Patent Application Publication
(10) Pub. No.: US 2023/0334125 A1
(43) Pub. Date: Oct. 19, 2023

(54) CONTROLLING BILLING FOR APPLICATION INSTALLED IN IMAGE FORMING APPARATUS

(71) Applicant: Hewlett-Packard Development Company, L.P., Spring, TX (US)

(72) Inventors: Sejong KIM, Seongnam-si (KR); Junghun KIM, Seongnam-si (KR); Minyoung SON, Seongnam-si (KR); Hyunwoo YOO, Seongnam-si (KR); Junhyung YOO, Seongnam-si (KR)

(21) Appl. No.: 18/028,814

(22) PCT Filed: Feb. 25, 2021
(86) PCT No.: PCT/US2021/019504

§ 371 Date: Mar. 28, 2023

(30) Foreign Application Priority Data
Sep. 29, 2020 (KR) 10-2020-0127532

(51) Int. Cl. G06F 21/10; G06F 11/34

(52) U.S. Cl. CPC G06F 21/105; G06F 11/3476; G06F 2221/0764; G06F 2221/0775

(57) ABSTRACT

An application management server includes: a communications unit to receive status information regarding applications installed in an image forming device; and a processor to prevent billing for an application that is classified, based on the status information, as not having a log of normal operation or as being incapable of normal operation.

### BACKGROUND

There exist many different types of image forming devices, including dedicated printers, scanners, photocopiers, facsimile machines, etc., and also multifunction products (MFPs). An MFP acts as an all-in-one solution to provide a combination of, e.g., print, photocopy, scan, and fax functions.

In addition to the basic functions such as photocopy, print, and scan, an image forming device may provide a variety of additional functions through applications installed therein. Such applications may include a free application, which is unaccompanied by any usage fees, and/or a paid application that is associated with pricing on a pay-for-use basis. When the paid application is properly installed in an image forming device and then used in a normal operation by a user thereof, the user is billed for that use.

### BRIEF DESCRIPTION OF THE DRAWINGS

FIG. 1 is a schematic illustration of an example of a system, including an image forming device and an application management server.

FIG. 2 is a diagram illustrating an example of the image forming device of FIG. 1.

FIG. 3 is a schematic illustration of an example of information stored in a memory of the image forming device of FIG. 1.

FIG. 4 is a diagram illustrating an example of the application management server of FIG. 1.

FIG. 5 is a flow diagram illustrating an example of a method of application management.

FIG. 6 is a flow diagram illustrating an example process which may be employed in prevention of billing.

FIG. 7 is a flow diagram illustrating an example process of identifying a not-yet-deleted application.

FIG. 8 is a flow diagram illustrating an example process of identifying a deletion-failed application.

FIG. 9 is a flow diagram illustrating an example process of identifying an application that is currently being deleted.

FIG. 10 is a flow diagram illustrating an example process of verifying a license related to use of an application.

FIG. 11 is a flow diagram illustrating an example process of acquiring information regarding a launch log of an application.

FIG. 12 is a flow diagram illustrating an example process of acquiring information regarding an operation log of an application.

FIG. 13 is a schematic illustration of an example of a computer readable storage medium.

### DETAILED DESCRIPTION

Various examples of the present disclosure are provided for suitable billing for a paid application. In particular, certain examples described herein involve acquiring status information regarding paid applications and preventing billing for a paid application that is classified, based on the status information, as not having a log of normal operation or as being incapable of normal operation.

In an example, there is provided an application management server. The application management server includes a communications unit and a processor. The communications unit is to receive status information regarding applications installed in an image forming device. The processor is to prevent billing for an application that is classified, based on the status information, as not having a log of normal operation or as being incapable of normal operation.

In an example, there is provided an image forming device. The image forming device includes: a communications unit to communicate with an application management server; a memory to store status information regarding applications installed in the image forming device; and a processor to deliver the status information through the communications unit to the application management server and to control the installed applications based on a control command received, from the application management server, as a response to the delivering.

In those examples where the application management server operates in conjunction with the image forming device, billing is prevented for an application that is out of normal use or yet unused. Thus, it may be ensured that a user of the image forming device is not unexpectedly billed. Further, an administrator who supplies and maintains the image forming device may keep track of a status of the image forming device and provide backup servicing adequate for the status so that a product or service as provided by the administrator may be acceptable to a user.

Various terms used in the present disclosure are chosen from a terminology of commonly used terms in consideration of their function herein, which may be appreciated differently depending on an intention of a person skilled in the art, a precedent case, or an emerging new technology. In specific instances, some terms are ascribed their meanings as set forth in detail in the detailed description. Accordingly, the terms used herein are to be defined consistently with their meanings in the context of the present disclosure, rather than simply by their names.

The terms “comprising,” “including,” “having,” “containing,” etc. are used herein when specifying the presence of the elements listed thereafter. Unless otherwise indicated, these terms and variations thereof are not meant to exclude the presence or addition of other elements.

As used herein, the ordinal terms “first,” “second,” and so forth are meant to identify several similar elements. Unless otherwise specified, such terms are not intended to impose limitations, e.g., a particular order of these elements or of their use, but rather are used merely for referring to multiple elements separately. For instance, an element may be referred to in an example with the term “first” while the same element may be referred to in another example with a different ordinal number such as “second” or “third.” In such examples, such ordinal terms are not to limit the scope of the present disclosure. Also, the use of the term “and/or” in a list of multiple elements is inclusive of all possible combinations of the listed items, including any one or plurality of the items.

The term “image forming job” as used herein may encompass any of a variety of image-related jobs, such as a print job, a photocopy job, a scan job, a facsimile or other transmission job, a coating job, and the like, that involve an operation of forming an image and/or other processing operations, e.g., creation, generation and/or transfer of an image file.

The term “image forming device” as used herein may encompass any of a variety of devices, such as a printer, a scanner, a photocopier, a facsimile machine, an MFP, a display device, and the like, that are capable of performing an image forming job. In some examples, an image forming device may be a two-dimensional (2D) or three-dimensional (3D) image forming device.

The term “user” as used herein may refer to a person who manipulates an image forming device to operate an image forming job. Further, the term “administrator” as used herein may refer to a person who has access to the entire functionality of an image forming device. In some examples, one person may have both the roles of an administrator and a user.

Certain examples of the present disclosure will now be described in detail with reference to the accompanying drawings. The present disclosure may, however, be embodied in many different forms and should not be construed as limited to the examples set forth herein; rather, these examples are given in order to provide a better understanding of the scope of the present disclosure.

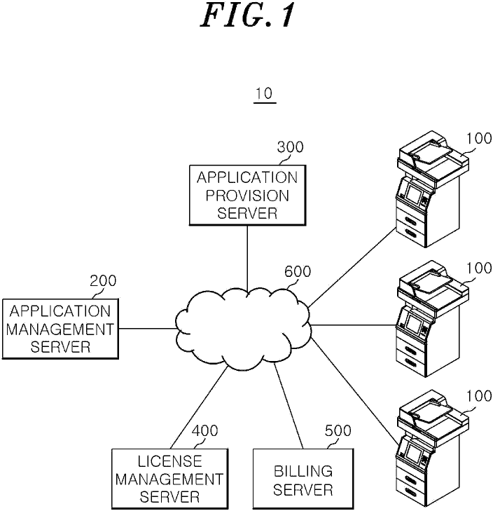

FIG. 1 is a schematic illustration of an example of a system 10. In the example of FIG. 1, the system 10 includes an example image forming device 100 (multiple image forming devices 100 are shown in the example of FIG. 1), an example application management server 200, an example application provision server 300, an example license management server 400, and an example billing server 500, all of which are interconnected via a network 600. Other examples of the system 10 are also contemplated, including the image forming device 100.

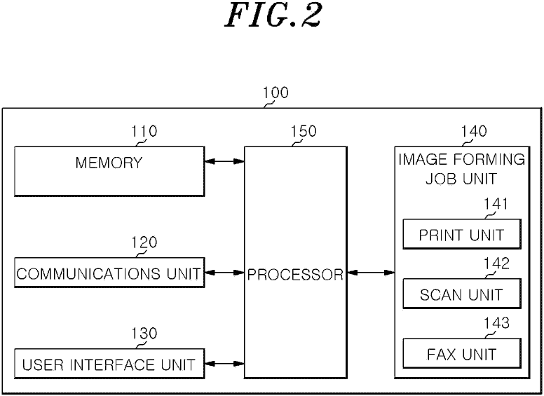

In the illustrated example, the image forming device 100 may be a dedicated type of image forming device, e.g., a dedicated printer, scanner, photocopier, or facsimile machine, or an MFP which functions as a combination of some dedicated image forming devices. In addition to the basic functions such as a photocopy, print, and scan, the image forming device 100 may provide a variety of additional functions through applications installed therein. Such applications may include a free application, which is unaccompanied by any usage fees, and/or a paid application that is associated with pricing on a pay-for-use basis. These and other features of the image forming device 100 are described in greater detail below with reference to FIG. 2.

In the example of FIG. 1, the application provision server 300 provides an application for the image forming device 100. For instance, a developer who created an application may upload the application to the application provision server 300. Thus, a user of the image forming device 100 may download the application from the application provision server 300 to the image forming device 100. In turn, the downloaded application is installed in the image forming device 100 so that the user may run the installed application on the image forming device 100.

In the illustrated example, the application management server 200 manages applications installed in the image forming device 100. In particular, the application management server 200 may assist an administrator of the image forming device 100, who may supply and maintain the image forming device 100, to check what applications are installed in the image forming device 100 and whether or not the installed applications are in normal operation. For instance, upon request by an entity, the application management server 200 may obtain, from the image forming device 100, status information regarding applications installed therein and provide the status information to the requesting entity. These and other features of the application management server 200 are described in greater detail below with reference to FIG. 4.

In the illustrated example, the license management server 400 manages licenses for operation of applications. For instance, the license management server 400 may retract a license for operation of an application that does not have a log of normal use or that is not capable of normal use. The retraction of the license prevents future use of the application in the image forming device 100.

In the example of FIG. 1, the billing server 500 performs billing for use of a paid application installed in the image forming device 100. In particular, the billing server 500 may receive, from the application management server 200, a list of applications installed in the image forming device 100 and information regarding a degree or amount of use of the installed applications and then perform the billing based on the list and the information. In this regard, the billing server 500 may refrain from billing for an application for which the license is retracted by the license management server 400. Alternatively, the billing server 500 may refrain from billing for an application if instructed by the application management server 200.

Further details of the image forming device 100 and the application management server 200 will be discussed below.

FIG. 2 is a diagram illustrating an example of the image forming device 100. As shown in FIG. 2, the image forming device 100 may include a memory 110, a communications unit 120, a user interface (UI) unit 130, an image forming job unit 140, and a processor 150. Other implementations are also contemplated. In an example, the image forming device 100 may also include an additional component, e.g., a power supply unit to supply power to the above-mentioned components. In another example, the image forming device 100 may include some of, but not all of, the components shown in FIG. 2.

In some examples, the memory 110 may include any computer-readable storage medium that stores data in a non-transitory form. Thus, the memory 110 may be, for example, a random access memory (RAM), a read-only memory (ROM), and/or any other type of storage medium. The memory 110 may store therein a variety of information, for example, a set of instructions that are to be executed by the processor 150, a number of application programs, and/or other information.

More particularly, in some examples, the memory 110 may store or install therein a certain application that is designed to provide any of a variety of additional functions. As mentioned above, the application may be a free or a paid application.

Further, in some examples, the memory 110 may store a list of applications installed therein. In addition, the memory 110 may store status information regarding the installed applications, including: information regarding an application that has been requested, in an external request, to be deleted and has failed to be deleted; information regarding an application currently being deleted as requested in an external request; information regarding a license under which an application is to operate; log information regarding whether or not applications have been launched or not; and/or log information regarding whether or not applications have been in normal operation.

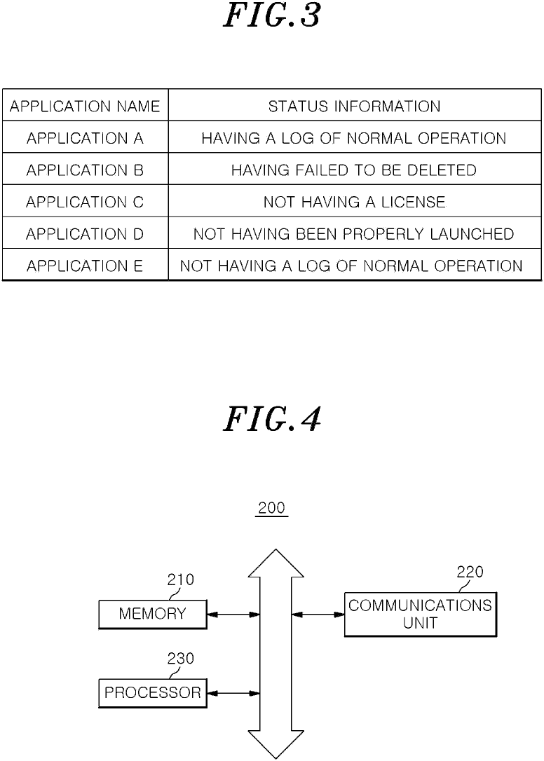

FIG. 3 is a schematic illustration of an example of the foregoing information stored in the memory 110, including an example list of installed applications and example status information regarding each of the applications.

In the example of FIG. 3, there are five applications installed in the image forming device 100, including: Application A, which is an application that has a log of normal operation; Application B, which is an application that has been requested to be deleted but failed; Application C, which is an application that does not have a license for operation thereof; Application D, which is an application that has never been properly launched; and Application E, which is an application that has never been normally operated.

In some examples, the communications unit 120 may enable the image forming device 100 to communicate with other entities shown in FIG. 1. The communication unit 120 may include a variety of communications modules, for example, a wired communications module and/or a wireless communications module. The wired communications module may support at least one of a Local Area Network (LAN), a Universal Serial Bus (USB), a High Definition Multimedia Interface (HDMI), or any other suitable types of wired communication technologies. The wireless communications module may support at least one of Wi-Fi, Wi-Fi Direct, Bluetooth, Ultra-Wide Band (UWB), Long Term Evolution (LTE), Long Term Evolution-Advanced (LTE-A), Fifth Generation (5G), Near-Field Communication (NFC), or any other suitable types of wireless communication technologies.

In some examples, the Ul unit 130 may include an input unit to receive a variety of user inputs, e.g., a user input to select an image forming job to be performed, a user input to select various options related to the selected image forming job, a user input to execute an application installed in the image forming device 100, and the like. Examples of the input unit include a keyboard, a keypad, a physical button, a touch pad, a touch screen, and any other types of devices that can receive a variety of forms of user inputs.

In some examples, the Ul unit 130 may include an output unit to display a result of the image forming job and/or to output or provide a certain message or other information on, e.g., a status of the image forming device 100. Examples of the output unit include a display panel, a speaker, and any other types of devices that can provide a variety of outputs.

In some examples, the image forming job unit 140 may perform an image forming job including, e.g., printing, scanning, and/or facsimile transmission. In various examples, the image forming job unit 140 may include a print unit 141, a scan unit 142, and a fax unit 143, as shown in FIG. 2. In other configurations, for instance, the image forming job unit 140 may include a subset of the above-listed components or include additional components for processing of other image forming jobs.

For example, the print unit 141 may include a printing mechanism to form an image on a recording medium such as paper. Various examples of the printing mechanism include an electro-photographic mechanism, an inkjet mechanism, a thermal transfer mechanism, a direct thermal mechanism, and the like.

For example, the scan unit 142 may irradiate light onto a document and receive the light reflected therefrom to capture an image. In a particular example, an image sensor such as a charge coupled device (CCD) type sensor, a contact-type image sensor (CIS), or any other suitable types of image sensors may be used therein for image reading from a document. In this example, the scan unit 142 may have a flatbed structure in which an image sensor is to move to read an image from a document page placed fixedly on a specific location, a document feed structure in which document sheets are to be fed to allow a fixedly-positioned image sensor to read images therefrom, or a combination thereof.

For example, the fax unit 143 may include a component to scan an image and a component to print a received image file. These components may also be used by the scan unit 142 and the print unit 141, respectively. Further, the fax unit 143 may transfer a scanned image file to a destination or receive an image file from an external source.

In some examples, the processor 150 may execute at least one instructions stored in the memory 110. The processor 150 may also read other information stored in the memory 110. In addition, the processor 150 may store new information in the memory 110 and may update some information stored in the memory 110.

As such, the processor 150 may control the overall operation of the image forming device 100. In some examples, the processor 150 may be implemented with a central processing unit (CPU) or other processing circuitry to perform operations described below.

In various examples, the processor 150 may control applications, e.g., the listed applications of FIG. 3, to be installed on or deleted from the image forming device 100. Upon a request for execution of an installed application, the processor 150 may execute the application. In an example, during the execution of the application, the processor 150 may also operate some of the other components of the image forming device 100.

Further, the processor 150 may collect status information regarding applications installed in the image forming device 100. Examples of the collected status information include: a list of applications installed in the image forming device 100; information regarding an application that has been requested, in an external request, to be deleted but has failed to be deleted; information regarding an application that is currently being deleted as requested in an external request; information regarding a license under which an application is to operate; log information regarding whether or not applications have been launched; and log information regarding whether or not applications have been in normal operation.

Still further, the processor 150 may control the status information to be delivered to the application management server 200 and control the image forming device 100 based on a control command received from the application management server 200 as a response to the delivering. Examples of the control command include a command to delete an application, a command to stop deleting an application, a command to request for grant or delete a license to use an application to the license management server 400, and the like.

Now, details of the application management server 200 are further described below. FIG. 4 is a diagram illustrating an example implementation of the application management server 200. As shown in FIG. 4, the application management server 200 may include a memory 210, a communications unit 220, and a processor 230. Other implementations are also contemplated. In an example, the application management server 200 may also include an additional component, e.g., a power supply unit to supply power to the above-mentioned components. In another example, the application management server 200 may not include some of the components shown in FIG. 4.

In some examples, the memory 210 may include any computer-readable storage medium that stores data in a non-transitory form. Thus, the memory 210 may be, for example, a RAM, a ROM, and/or any other type of storage medium. The memory 210 may store therein a variety of information. In some examples, the memory 210 may store a set of instructions that are to be executed by the processor 230. Further, in some examples, the memory 210 may store information regarding an application that is requested to be deleted. Specifically, the application management server 200 may be instructed by an administrator of the application management server 200 to delete a particular application from the image forming device 100. In such case, the processor 230 may store the instruction in the memory 210.

In some examples, the communications unit 220 may enable the application management server 200 to communicate with each of the entities shown in FIG. 1. The communications unit 220 may be used to receive certain information, for example, the above-mentioned status information, from the image forming device 100. The communications unit 220 may include a variety of communications module, for example, a wired communications module and/or a wireless communications module. The wired communications module may support at least one of a LAN, a USB, an HDMI, or any other suitable types of wired communication technologies. The wireless communications module may support at least one of Wi-Fi, Wi-Fi Direct, Bluetooth, UWB, LTE, LTE-A, 5G, NFC, or any other suitable types of wireless communication technologies.

In some examples, the processor 230 may execute at least one instructions stored in the memory 210. The processor 230 may also read other information stored in the memory 210. In addition, the processor 230 may store new information in the memory 210 and may update some information stored in the memory 210.

As such, the processor 230 may control the overall operation of the application management server 200. In some examples, the processor 230 may be implemented with a CPU or other processing circuitry to perform the operations described below.

In various examples, the application management server 200 may operate the processor 230 to send, to the image forming device 100, a request for status information regarding applications installed in the image forming device 100.

Further, the processor 230 may acquire the status information from the image forming device 100 and then classify, based on the status information, an application installed in the image forming device 100, as one of the following: being normal; not having a log of normal operation; and being incapable of normal operation.

In these examples, an application is classified as being normal in case the application has been properly installed, has a log of normal operation, and is also still capable of normal operation.

In these examples, an application is classified as not having a log of normal operation in case the application has been properly installed but never launched in view of the launch log information that is used to record whether or not the application has been launched, or in case the application has been properly installed but never been in normal operation in view of operation log information that is used to record whether or not the application has been in normal operation.

In these examples, the application is classified as being incapable of normal operation in case the application has not been properly installed or in case the application has been properly installed but has no license to operate the application or the license has been expired. In a particular example, if the application has been requested to be deleted but failed, if the application is currently being deleted, or if the license to operate the application is unavailable or has expired, the application may be classified as being incapable of normal operation.

For use in the classification, the communications unit 220 may receive the status information including information indicating whether applications have been properly installed, information regarding licenses to operate applications, etc., as well as the launch log information and the operation log information. Such status information may be information recorded or composed by the processor 150 of the image forming device 100.

Still further, the processor 230 may perform a control operation to prevent billing for the application that is classified as not having a log of normal operation or as being incapable of normal operation. To this end, several approaches may be employed. In an example, the processor 230 may deliver the information regarding such application directly to the billing server 500. In another example, the processor 230 may send, to the license management server 400, the information regarding the application, together with a request for management of a license of the application, for example, a retraction of the license.

Now, an example process flow of a method of application management is discussed below.

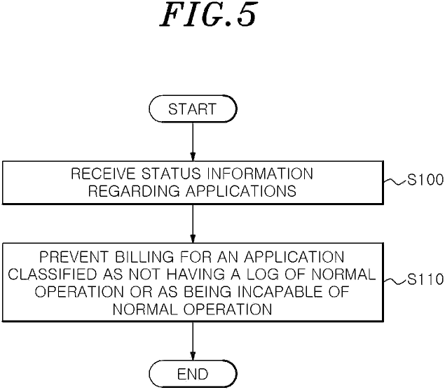

FIG. 5 is a flow diagram illustrating an example of a method of application management. The example method may be performed by the application management server 200. Other example flows are also contemplated.

At S100, status information regarding applications installed in the image forming device 100 is received.

At S110, billing is prevented for an application that is classified, based on the status information, as not having a log of normal operation or as being incapable of normal operation.

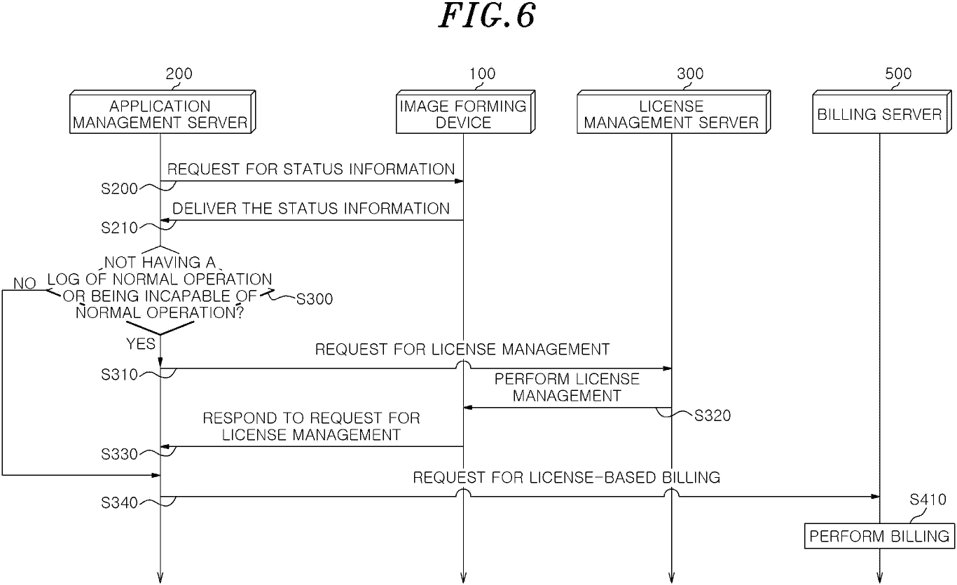

Further details of the example method will be described below in connection with FIG. 6.

FIG. 6 is a flow diagram illustrating an example process which may be employed to prevent billing for an application.

At S200, the application management server 200 operates the processor 230 to send, to the image forming device 100, a request for status information regarding applications installed in the image forming device 100.

At S210, the image forming device 100 delivers, to the application management server 200, the status information as a response to the request made at S200.

In some examples, irrespective of whether the request is made at S200, the image forming device 100 may periodically deliver, to the application management server 200, the status information regarding the applications that are installed in the image forming device 100.

At S300, if the status information is acquired from the image forming device 100, the processor 230 of the application management server 200 classifies, based on the status information, an application installed in the image forming device 100, as being normal, as not having a log of normal operation, or as being incapable of normal operation. Such classification may be performed as described above.

If the application is classified at S300 as being normal, at S340, the processor 230 requests the billing server 500 to bill for the application. Such request may be made provided that a license for the application is valid. At S410, the billing server 500 performs the billing accordingly.

If the application is classified at S300 as not having a log of normal operation or as being incapable of normal operation, the processor 230 prevents billing for the application. In this regard, FIG. 6 shows an example approach of using the license management server 400 to prevent billing. Specifically, at S310, the application management server 200 operates the processor 230 to send, to the license management server 400, a request for license management. Such request may be a request for retraction of a license for operation of the application. Then, at S320, the license management server 400 issues, to the image forming device 100, an instruction to retract the license for the operation of the application. At S330, the image forming device 100 operates the processor 150 to retract the license and thereafter sends a result of the retraction, as a response, to the application management server 200.

Given that the license is retracted, at S340, the application management server 200 sends, to the billing server 500, a request for billing based on the license. Then, at S410, the billing server 500 performs the license-based billing as requested.

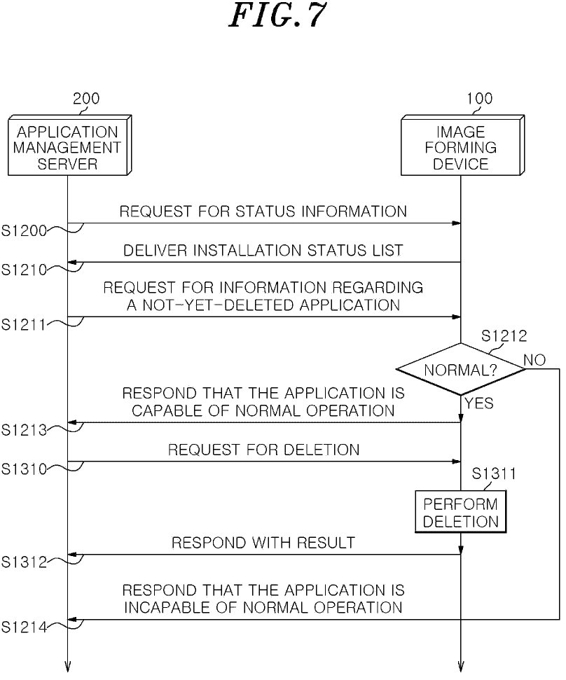

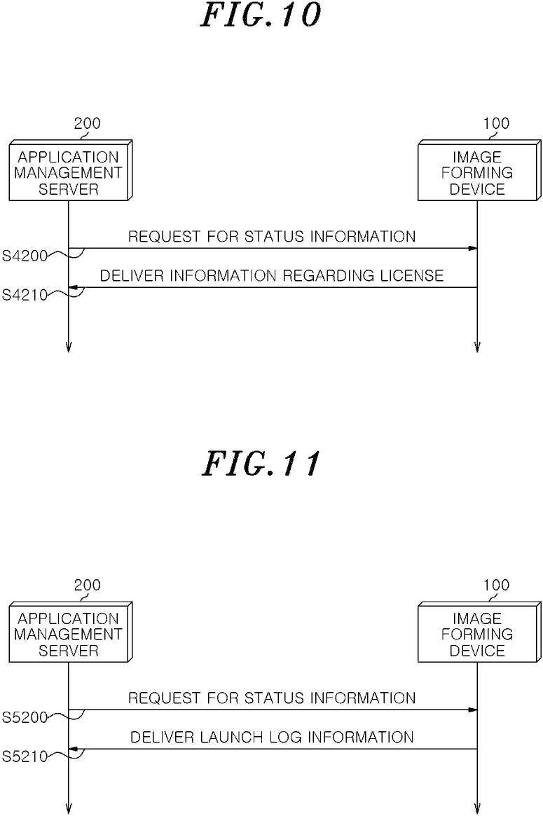

Each of FIGS. 7 to 10 shows some operations of an example process in which an application is classified as being incapable of normal operation so that billing for the application is to be prevented. Each of FIGS. 11 and 12 shows some operations of an example process in which an application is classified as not having a log of normal operation so that billing for the application is to be prevented. For simplicity, in FIGS. 7 to 12, certain operations are omitted and such omitted operations may be assumed to be performed by, e.g., the processor 230 of the application management server 200, to prevent billing as described in FIG. 5 or FIG. 6.

FIG. 7 is a flow diagram illustrating an example process which may be incorporated into the flow diagram of FIG. 5 or FIG. 6 to prevent billing for an application classified as being incapable of normal operation.

At S1200, the application management server 200 operates the processor 230 to send, to the image forming device 100, a request for status information regarding applications installed in the image forming device 100.

At S1210, the image forming device 100 delivers, to the application management server 200, the status information as a response to the request made at S1200. In this example, the status information includes an installation status list of applications installed in the image forming device 100. This list may indicate what types of applications are installed in the image forming device 100.

Then, upon acquiring, from the memory 210, information regarding an application that has been requested by an administrator of the application management server 200 to be deleted, the processor 230 compares this information with the list received at S1210 so as to obtain information regarding an application that has been requested to be deleted but still remains installed (i.e., not-yet-deleted) in the image forming device 100.

The not-yet-deleted application is to be checked whether it is capable of normal operation or not. Therefore, the processor 230 may request information on the application that has been requested to be deleted but still remains installed to the image forming device 100, as shown at S1211.

Upon receiving the above request, the image forming device 100 checks the status of the application at S1212.

If the application remains properly installed in the image forming device 100 (S1212, ‘YES’), at S1213, the image forming device 100 sends to the application management server 200 a response indicating that the application is capable of normal operation. At S1310, the application management server 200 operates the processor 230 to send, to the image forming device 100, a request for deletion of the application that has not yet been deleted. At S1311, the image forming device 100 deletes the application according to the request. In turn, at 1312, the image forming device 100 sends a result of the deletion, as a response, back to the application management server 200. The processor 230 of the application management server 200 may then perform a control operation to prevent billing for the deleted application.

If the application is not properly installed any more in the image forming device 100 (S1212, ‘NO’), the image forming device 100 sends to the application management server 200 a response indicating the application is incapable of normal operation (S1214). In turn, the processor 230 of the application management server 200 may perform a control operation to prevent later billing for this application.

As such, in an example, billing may be prevented for an application that has been requested to be deleted but is still included in the installation status list.

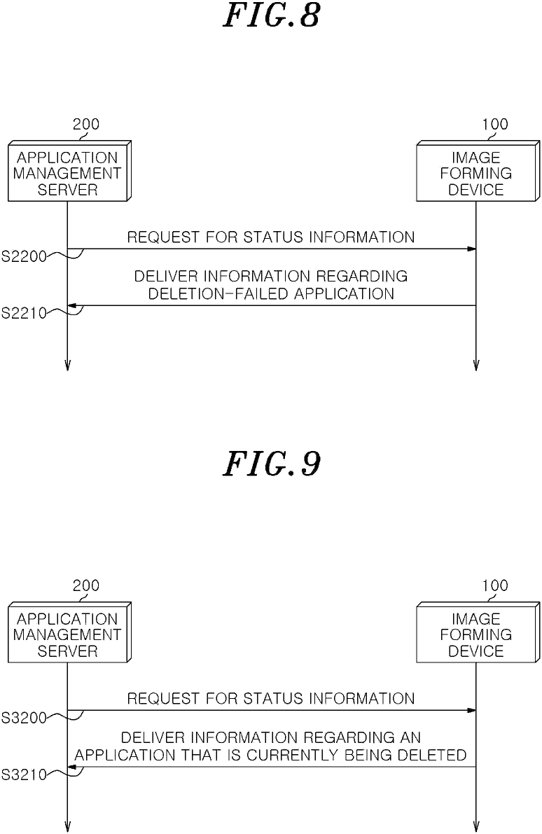

FIG. 8 is a flow diagram illustrating an example process which may be incorporated into the flow diagram of FIG. 5 or FIG. 6 to prevent billing for another application classified as being incapable of normal operation.

At S2200, the application management server 200 operates the processor 230 to send, to the image forming device 100, a request for status information regarding applications installed in the image forming device 100.

At S2210, the image forming device 100 delivers, to the application management server 200, the status information as a response to the request made in S2200. In this example, the status information includes information regarding an application that has been requested to be deleted but failed.

Then, the processor 230 of the application management server 200 may perform a control operation to prevent billing for the application that has failed to be deleted. For further details on the prevention of the billing, reference may be made to the description set forth with respect to FIGS. 4 to 6.

As such, in an example, billing may be prevented for an application that has been requested to be deleted but failed.

FIG. 9 is a flow diagram illustrating an example process which may be incorporated into the flow diagram of FIG. 5 or FIG. 6 to prevent billing for still another application classified as being incapable of normal operation.

At S3200, the application management server 200 operates the processor 230 to send, to the image forming device 100, a request for status information regarding applications installed on the image forming device 100.

At S3210, the image forming device 100 delivers, to the application management server 200, the status information as a response to the request made in S3200. In this example, the status information includes information regarding an application that is currently being deleted.

Then, the processor 230 of the application management server 200 may perform a control operation to prevent billing for the application that is currently being deleted. For further details on the prevention of billing, reference may be made to the description set forth with respect to FIGS. 5 and 6.

As such, in an example, billing may be prevented for an application that has been requested to be deleted and is currently being deleted.

FIG. 10 is a flow diagram illustrating an example process which may be incorporated into the flow diagram of FIG. 5 or FIG. 6 to prevent billing for yet another application classified as being incapable of normal operation.

At S4200, the application management server 200 operates the processor 230 to send, to the image forming device 100, a request for status information regarding applications installed on the image forming device 100.

At S4210, the image forming device 100 delivers, to the application management server 200, the status information as a response to the request made in S4200. In this example, the status information includes information regarding a license under which an application installed in the image forming device 100 is to operate.

Then, based on the information, the processor 230 of the application management server 200 may perform a control operation to prevent billing for the application if the license is unavailable or has expired. For further details on the prevention of billing, reference may be made to the description set forth with respect to FIGS. 5 and 6.

As such, in an example, billing may be prevented for an application for which a license is not available or has expired.

FIG. 11 is a flow diagram illustrating an example process which may be incorporated into the flow diagram of FIG. 5 or FIG. 6 to prevent billing for an application classified as not having a log of normal operation.

At S5200, the application management server 200 operates the processor 230 to send, to the image forming device 100, a request for status information regarding applications installed on the image forming device 100.

At S5210, the image forming device 100 delivers, to the application management server 200, the status information as a response to the request made in S5200. In this example, the status information includes launch log information indicating whether or not applications installed in the image forming device 100 have been launched.

Then, based on the launch log information, the processor 230 of the application management server 200 may perform a control operation to prevent billing for an application that has never been launched. For further details on the prevention of billing, reference may be made to the description set forth with respect to FIGS. 5 and 6.

As such, in an example, billing may be prevented for an application that has never been launched.

FIG. 12 is a flow diagram illustrating an example process which may be incorporated into the flow diagram of FIG. 5 or FIG. 6 to prevent billing for another application classified as not having a log of normal operation.

At S6200, the application management server 200 operates the processor 230 to send, to the image forming device 100, a request for status information regarding applications installed on the image forming device 100.

At S6210, the image forming device 100 delivers, to the application management server 200, the status information as a response to the request made in S6200. In this example, the status information includes operation log information indicating whether or not applications installed in the image forming device 100 have been in normal operation.

Then, based on the operation log information, the processor 230 of the application management server 200 may perform a control operation to prevent billing for an application that has never been in normal operation. For further details on the prevention of billing, reference may be made to the description set forth with respect to FIGS. 5 and 6.

As such, in an example, billing may be prevented for an application that has never been in normal operation.

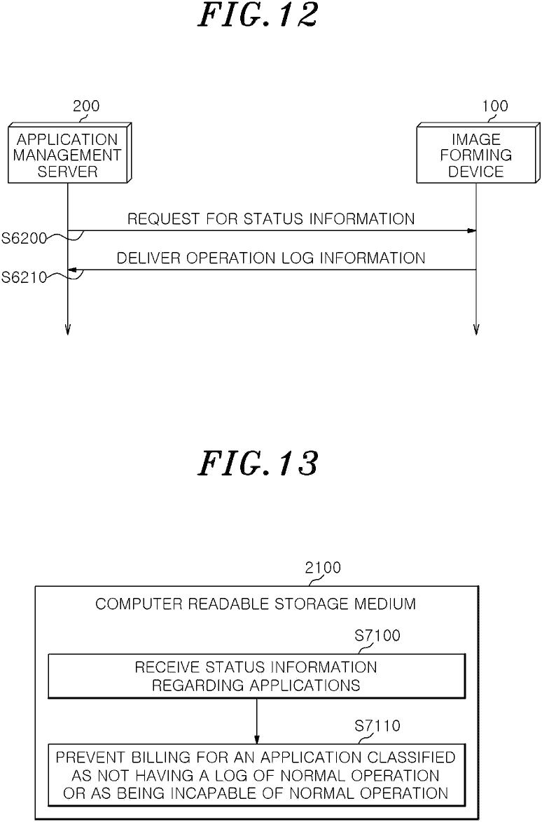

FIG. 13 is a schematic illustration of an example of a computer readable storage medium 2100 that stores a computer program. When executed by a processor, e.g., the processor 230 of the application management server 200, the computer program may implement some operations of the aforementioned methodology. As shown in FIG. 13, the computer program stored in the computer readable storage medium 2100 may include a set of program instructions S7100 and S7110 that direct the processor to perform specific operations.

In the example of FIG. 13, program instructions S7100 are executable to receive status information regarding applications installed in the image forming device 100 is performed.

Further, program instructions S7110 are executable to prevent billing for an application that is classified, based on the status information, as not having a log of normal operation or as being incapable of normal operation is performed.

For further details on the example operations, reference may be made to the above description of the application management server 200.

The computer readable storage medium 2100 may be a non-transitory readable medium. The term “non-transitory readable medium” as used herein refers to a medium that is capable of semi-permanently storing data and is readable by an apparatus, rather than a medium, e.g., a register, a cache, a volatile memory device, etc., that temporarily stores data. For example, the foregoing program instructions may be stored and provided in a CD, a DVD, a hard disk, a Blu-ray disc, a USB, a memory card, a ROM device, or any of other types of non-transitory readable media.

In a particular example, the methodology disclosed herein may be incorporated into a computer program product. The computer program product may be available as a product for trading between a seller and a buyer. The computer program product may be distributed in the form of a machine-readable storage medium, e.g., compact disc read-only memory (CD-ROM), or distributed online through an application store, e.g., PlayStore™. For online distribution, at least a portion of the computer program product may be temporarily stored, or temporarily created, in a storage medium such as a server of the manufacturer, a server of the application store, or a storage medium such as a memory of a relay server.

The foregoing description has been presented to illustrate and describe some examples in detail. It should be appreciated by those skilled in the art that many modifications and variations are possible in light of the above teaching. In various examples, suitable results may be achieved if the above-described techniques are performed in a different order, and/or if some of the components of the above-described systems, architectures, devices, circuits, and the like are coupled or combined in a different manner, or substituted for or replaced by other components or equivalents thereof.

Therefore, the scope of the disclosure is not to be limited to the precise form disclosed, but rather defined by the following claims and equivalents thereof.

What is claimed is:

1. An application management server, comprising:
a communications unit to receive status information regarding applications installed in an image forming device; and
a processor to prevent billing for an application that is classified, based on the status information, as not having a log of normal operation or as being incapable of normal operation.

2. The application management server of claim 1, wherein the processor is to send, to a license management server that manages licenses for operation of applications, a request for management of a license for operation of the application that is classified as not having a log of normal operation or as being incapable of normal operation, wherein the request for management of the license sent to the license management server is to prevent the operation of the application at the image forming device.

3. The application management server of claim 1, wherein the application management server further comprises a memory to store information regarding an application that has been requested to be deleted, wherein the status information comprises an installation status list of applications installed in the image forming device, and wherein the processor is to classify, as being incapable of normal operation, the application that has been requested to be deleted and is included in the installation status list.

4. The application management server of claim 1, wherein the status information comprises information regarding an application that has been requested to be deleted but has failed to be deleted, and wherein the processor is to classify, as being incapable of normal operation, the application that has failed to be deleted.

5. The application management server of claim 1, wherein the status information comprises information regarding an application that is currently being deleted, and wherein the processor is to classify, as being incapable of normal operation, the application that is currently being deleted.

6. The application management server of claim 1, wherein the status information comprises information regarding a license under which an application is to operate, and wherein if the license is unavailable or has expired, the processor is to classify, as being in capable of normal operation, the application that is to operate under the license.

7. The application management server of claim 1, wherein the status information comprises launch log information indicating whether or not applications have been launched, and wherein the processor is to identify, based on the launch log information, an application that has never been launched and to classify the identified application as not having a log of normal operation.

8. The application management server of claim 1, wherein the status information comprises operation log information indicating whether or not applications have been in normal operation, and wherein the processor is to identify, based on the operation log information, an application that has never been in normal operation and to classify the identified application as not having a log of normal operation.

9. An image forming device, comprising:
a communications unit to communicate with an application management server;
a memory to store status information regarding applications installed in the image forming device; and
a processor to deliver the status information through the communications unit to the application management server and to control the installed applications based on a control command received from the application management server as a response to the delivering of the status information.

10. The image forming device of claim 9, wherein the status information comprises an installation status list of applications installed in the image forming device.

11. The image forming device of claim 9, wherein the status information comprises information regarding an application that has been requested to be deleted but has failed to be deleted.

12. The image forming device of claim 9, wherein the status information comprises information regarding an application that is currently being deleted.

13. The image forming device of claim 9, wherein the status information comprises information regarding a license under which an application is to operate.

14. The image forming device of claim 9, wherein the status information comprises launch log information indicating whether or not applications have been launched.

15. A computer readable storage medium storing a computer program that when executed causes a processor to:
receive status information regarding applications installed in an image forming device; and
prevent billing for an application that is classified, based on the status information, as not having a log of normal operation or as being incapable of normal operation.
